(19) United States
(12) Patent Application Publication
(10) Pub. No.: US 2025/0309458 A1
(43) Pub. Date: Oct. 2, 2025

(54) BATTERY SYSTEM

(71) Applicant: VOLVO TRUCK CORPORATION, Göteborg (SE)

(72) Inventors: Benjamin MCCARTHY, Åsa (SE); Istaq Ahmed, Göteborg (SE); Romulo Barbieri, Hisingsbacka (SE)

(73) Assignee: VOLVO TRUCK CORPORATION, Göteborg (SE)

(21) Appl. No.: 19/089,615

(22) Filed: Mar. 25, 2025

(30) Foreign Application Priority Data
Mar. 27, 2024 (EP) 24166809.4

(51) Int. Cl. H01M 50/317; B60K 11/02; B60L 58/10; B60T 11/26; H01M 10/42; H01M 10/613; H01M 10/625; H01M 10/6568; H01M 50/691

(52) U.S. Cl. CPC H01M 50/317; H01M 10/425; H01M 10/613; H01M 10/625; H01M 10/6568; H01M 50/691; B60K 11/02; B60L 58/10; B60T 11/26; H01M 2220/20

(57) ABSTRACT

A battery system includes a liquid-cooled battery pack and a compressed air supply connected to a high pressure inlet valve of the battery pack and connectable to an air-controlled brake system of a vehicle, wherein the battery system is configured to control an internal pressure of the battery pack to be greater than an ambient air pressure.

### TECHNICAL FIELD

The disclosure relates generally to battery systems. In particular aspects, the disclosure relates to battery systems comprising liquid-cooled battery packs. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

A battery pack is a collection of individual batteries or cells assembled together to provide electrical energy for various devices or applications. These packs are commonly used in electronic devices, electric vehicles, renewable energy systems, and portable power sources.

Generally, during discharge (or charging in case of re-chargeable battery packs) of a battery pack heat may be generated. In order to provide a suitable operating temperature for battery packs, some form of thermal management system is generally provided to cool the battery pack. It is common in battery system for commercial vehicles is to use a liquid coolant as a heat exchange medium

To avoid leakage of coolant into the battery pack, battery packs are generally sealed. If sealing of a battery pack is compromised for one reason or another, contaminants such as coolant, water or dust may leak from the battery pack reducing performance of the battery pack.

### SUMMARY

According to a first aspect of the disclosure, a battery system is presented. The battery system comprises a liquid-cooled battery pack and a compressed air supply connected to a high pressure inlet valve of the battery pack and connectable to an air-controlled brake system of a vehicle, wherein the battery system is configured to control an internal pressure of the battery pack to be greater than an ambient air pressure. The first aspect of the disclosure may seek to reduce a risk that contaminants enter a battery pack in case a sealing of the battery pack is compromised. A technical benefit may include increasing a lifetime of the battery back and reducing a risk that flammable contaminants enter the battery pack causing smoke or even fires.

Optionally in some examples, including in at least one preferred example, the battery pack comprises a pressure relief valve configured to open responsive to the internal pressure of the battery pack being above a pressure relief threshold, and the battery system is further configured to control the internal pressure of the battery pack to be below the pressure relief threshold. A technical benefit may include enabling a controlled over pressure inside the battery pack in combination with a pressure relief valve.

Optionally in some examples, including in at least one preferred example, the internal pressure of the battery pack is controlled by a pressure reducing valve arranged between and in fluid connection with the compressed air supply and the high pressure inlet valve. A technical benefit may include reducing a cost for the battery pack as requirements, of e.g. maximum pressure tolerance of the battery pack, may be reduced.

Optionally in some examples, including in at least one preferred example, the battery system is further configured to control the internal pressure of the battery pack to be greater than a predetermined internal pressure of a cooling liquid of a cooling system configured to cool the battery pack. A technical benefit may include ensuring that coolant does not leak into the battery pack even in cases where e.g. an outer wall of coolant lines also serve as an inner wall for a housing of the battery pack.

Optionally in some examples, including in at least one preferred example, the battery pack further comprises a controllable outlet valve and the battery system is further configured to control the controllable outlet valve to controllably release air from the battery pack. A technical benefit may include enabling a controlled evacuation of air from the battery pack. For instance, at startup, air of the battery pack may be replaced to ensure that air inside the battery pack is dry.

Optionally in some examples, including in at least one preferred example, the controllable outlet valve is arranged at an, during use, vertically lower portion of the battery pack to allow draining of moisture from the battery pack. A technical benefit may include enabling a controlled evacuation (release) of not only air from the battery pack, but also any liquid accumulated (from e.g. condensation) inside the battery pack.

Optionally in some examples, including in at least one preferred example, the battery system further comprises processing circuitry configured to control the internal pressure of the battery pack. A technical benefit may include enabling, an at least partly, computerized control of the battery system.

Optionally in some examples, including in at least one preferred example, the battery system further comprises a pressure relief valve configured to open responsive to the internal pressure of the battery pack being above a pressure relief threshold, and the battery system is further configured to control the internal pressure of the battery pack to be below the pressure relief threshold; the internal pressure of the battery pack is controlled by a pressure reducing valve arranged between and in fluid connection with the compressed air supply and the high pressure inlet valve; the high pressure air supply comprises an air dryer; the battery system is configured to control the internal pressure of the battery pack to be greater than a predetermined internal pressure of a cooling liquid of a cooling system configured to cool the battery pack; the battery pack further comprises a controllable outlet valve and the battery system is further configured to control the controllable outlet valve to controllably release air from the battery pack; the controllable outlet valve is arranged at an, during use, vertically lower portion of the battery pack to allow draining of moisture from the battery pack; the battery system further comprising processing circuitry configured to control the internal pressure of the battery pack. A technical benefit may include all benefits listed above.

According to a second aspect of the disclosure, a vehicle is presented. The vehicle comprises a battery system of the first aspect and an air-controlled brake system wherein a reservoir tank of the air-controlled brake system is operatively connected to the compressed air supply of the battery system. The second aspect of the disclosure may seek to reduce a risk that contaminants enter a battery pack in case a sealing of the battery pack is compromised. A technical benefit may include increasing a lifetime of the battery back and reducing a risk that flammable contaminants enter the battery pack causing smoke or even fires.

Optionally in some examples, including in at least one preferred example, the vehicle is a heavy-duty vehicle.

According to a third aspect of the disclosure, a method for controlling an internal pressure of a liquid-cooled battery pack is presented. The method comprises providing high pressure air from a compressed air tank of an air-controlled brake system of a vehicle to a high pressure inlet valve of the battery pack, and controlling the internal pressure of the battery pack to be greater than an ambient air pressure. The third aspect of the disclosure may seek to reduce a risk that contaminants enter a battery pack in case a sealing of the battery pack is compromised. A technical benefit may include increasing a lifetime of the battery back and reducing a risk that flammable contaminants enter the battery pack causing smoke or even fires.

Optionally in some examples, including in at least one preferred example, the battery pack comprises a pressure relief valve configured to open responsive to the internal pressure of the battery pack being above a pressure relief threshold. The method further comprises controlling the internal pressure of the battery pack to be below the pressure relief threshold. A technical benefit may include enabling a controlled over pressure inside the battery pack in combination with a pressure relief valve.

Optionally in some examples, including in at least one preferred example, the battery pack further comprises a controllable outlet valve. The method further comprises controlling the controllable outlet valve to controllably release air from the battery pack. A technical benefit may include enabling a controlled evacuation of air from the battery pack. For instance, at startup, air of the battery pack may be replaced to ensure that air inside the battery pack is dry.

Optionally in some examples, including in at least one preferred example, the method further comprises controlling the internal pressure of the battery pack to be greater than a predetermined internal pressure of a cooling liquid (a coolant) of a cooling system configured to cool the battery pack. A technical benefit may include ensuring that coolant does not leak into the battery pack even in cases where e.g. an outer wall of coolant lines also serve as an inner wall for a housing of the battery pack.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

### BRIEF DESCRIPTION OF THE DRAWINGS

Examples are described in more detail below with reference to the appended drawings.

FIG. 1 is an exemplary schematic view of a vehicle according to an example.

FIG. 2 is an exemplary schematic view of an air-controlled brake system according to an example.

FIG. 3 is an exemplary schematic view of a battery system according to an example.

FIG. 4 is an exemplary schematic view of a battery system according to an example.

FIG. 5 is an exemplary schematic view of a method according to an example.

FIG. 6 is an exemplary schematic view of a computer program product according to an example.

FIG. 7 is an exemplary schematic view of a computer program product being loaded onto processing circuitry according to an example.

### DETAILED DESCRIPTION

The detailed description set forth below provides information and examples of the disclosed technology with sufficient detail to enable those skilled in the art to practice the disclosure.

Battery packs are made up of battery cells, battery cells have a narrow ideal range of operational temperature to provide maximum performance and lifetime whilst ensuring safe use. Further, as mentioned, battery cells generate heat during discharge and charge. To this end, battery packs are provided with a thermal management system to cool the battery pack down or heat the battery pack up in order to keep the battery pack within the ideal range of operational temperature. Most commonly on commercial vehicle battery application, is to use liquid coolant as the heat exchange medium. Liquid coolant is circulated inside the pack through a coolant circuit comprising of pipes, connectors, valves, heat exchangers, etc. The liquid coolant is, most commonly, made of a mix of glycol and pure water. As a result, the coolant may conduct electricity, so the contact of coolant with components under voltage may lead to short circuit and/or current leakage. Short circuit inside a battery pack is a safety issue as it may damage the battery cell. Therefore, the internal coolant circuit must be tight in order to prevent coolant leakage inside the battery pack. The safety issues may occur due to ingress of ambient water or dust. To this end a battery pack, specifically a battery pack of a vehicle, is generally substantially hermetically sealed to avoid contaminants from entering the battery pack.

Even with a substantially sealed system, e.g. liquid/moisture may, due to vibrations, cracks in a housing etc. be present within the battery pack even if a very complex and expensive seal is provided. Moisture may condense or reach a level where it interacts with electrical components of the battery pack risking undesired and unforeseen dangerous consequences. Such challenges may be addressed by increasing a strength and durability of the battery pack and/or by mounting the battery pack at a protected location to avoid damage and contaminants. However, such solutions are generally costly and may trade off efficiency and performance in order to reduce a risk of compromising the seal of the battery pack.

Some solutions may involve filling the battery pack with fire retardant foam to limit the available space for moisture to accumulate. Although such actions at least to a part addresses moisture problems, it makes for difficult or impossible service of the battery pack and increases costs and weight (and thereby energy consumption if used onboard a vehicle) of the battery pack.

Another solution is to create areas within the battery pack where the moisture can accumulate wherefrom moisture may be provided to a drain. However, such solutions introduce unnecessary packaging constraints and inefficiencies.

The present disclosure will present a solution that is simple to implement and cost-efficient. The solution is implementable in a vehicle with only minor modifications required to sealing of battery packs and utilization of components and devices already available at the vehicle.

By controlling an internal pressure of a battery pack to be above an ambient pressure, contaminants will be prevented from entering the battery pack. A pressure inside the battery pack (internal pressure) is increased by connecting the battery pack to an air supply of a brake system of the vehicle. The brake system will provide a steady, secure, reliable and substantially endless supply of dry pressurized air for the battery pack. Even if the sealing of the battery pack is compromised, operation of the battery pack may be allowed as a risk of e.g. coolant (in case of a liquid-cooled battery pack) or other contaminants leaking into the battery pack is reduced.

Compared to e.g. the foam solution mentioned above, a foam introduces air gaps into which humid air may leak if a seal of the battery pack is damaged, high pressure air (air above ambient pressure) will prevent moist air from entering the battery pack.

Providing a drain of the battery pack and areas for condensation to accumulate generally still allow condensation to form at any inside the battery pack before it is directed (by e.g. gravity) to specific locations at the drain. This subjects an inside of the battery pack to moisture, albeit for a shorter time period, but the risk of damage, corrosion etc. is still increased compared to using high pressure air which will prevent moist air from entering the battery pack.

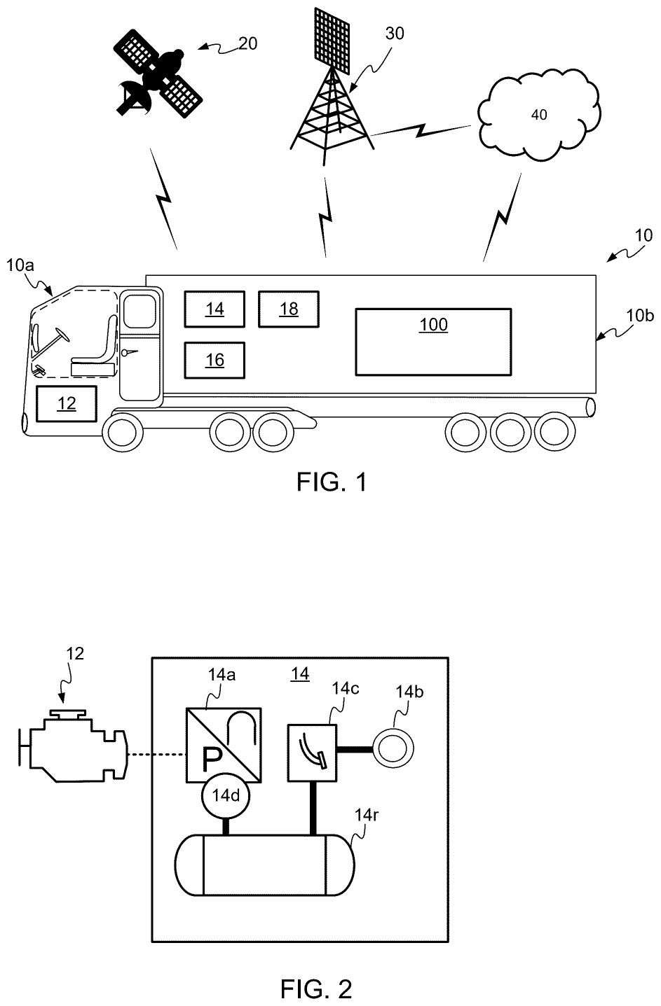

FIG. 1 is an exemplary schematic side view of a heavy-duty vehicle 10 (hereinafter referred to as vehicle 10) compatible with the teachings of the present disclosure. The vehicle 10 comprises a tractor unit 10a which is arranged to tow a trailer unit 10b. In other examples, other vehicles may be employed, e.g., trucks, buses, and construction equipment. The vehicle 10 comprises all vehicle units and associated functionality to operate as expected, such as a powertrain, chassis, and various control systems. The vehicle 10 comprises one or more propulsion sources 12. The propulsion source 12 may be any suitable propulsion source 12 exemplified by, but not limited to, one or more or a combination of an electrical motor, a combustion engine such as a diesel, gas or gasoline powered engine. The vehicle 10 further comprises an energy source 100 suitable for providing energy for the propulsion source 12. That is to say, if the propulsion source 12 is an electrical motor, a suitable energy source 100 would be a battery pack or a fuel cell. The vehicle 10 further comprises a brake system 14, preferably an air-controlled brake system 14. The vehicle 10 may further comprise sensor circuitry 16 arranged to detect, measure, sense or otherwise obtain data relevant for operation of the vehicle 10 including devices and systems connected to the vehicle 10. The sensor circuit 16 may comprise one or more of an accelerometer, a gyroscope, a wheel Speed Sensor, an ABS sensor, a throttle position sensor, a fuel level sensor, a temperature Sensor, a pressure sensor, a rain sensor, a light sensor, proximity sensor, a lane departure warning sensor, a blind spot detection sensor, a TPMS sensor etc. Operational data relevant for operation of the vehicle 10 may include, but is not limited to, one or more of a speed of the vehicle 10, a weight of the vehicle 10, an inclination of the vehicle 10, a status of the energy source 100 of the vehicle 10 (state of charge, fuel level etc.), a current speed limit of a current road travelled by the vehicle 10, air-brake pressure etc. The vehicle 10 may further comprise communications circuitry 18 configured to receive and/or send communication. The communications circuitry 18 may be configured to enable the vehicle 10 to communicate with one or more external devices or systems such as a cloud server 40. The communication with the external devices or systems may be directly or via a communications interface such as a cellular communications interface 30, such as a radio base station. The cloud server 40 may be any suitable cloud server exemplified by, but not limited to, Amazon Web Services (AWS), Microsoft Azure, Google Cloud Platform (GCP), IBM Cloud, Oracle Cloud Infrastructure (OCI), DigitalOcean, Vultr, Linode, Alibaba Cloud, Rackspace etc. The communications interface may be a wireless communications interface exemplified by, but not limited to, Wi-Fi, Bluetooth, Zigbee, Z-Wave, LoRa, Sigfox, 2G (GSM, CDMA), 3G (UMTS, CDMA2000), 4G (LTE), 5G (NR) etc. The communication circuitry 18 may, additionally or alternatively, be configured to enable the vehicle 10 to be operatively connected to a Global Navigation Satellite System (GNSS) 20 exemplified by, but not limited to, global positioning system (GPS), Globalnaya Navigatsionnaya Sputnikovaya Sistema (GLONASS), Galileo, BeiDou Navigation Satellite System, Navigation with Indian Constellation (NavIC) etc. The vehicle 10 may be configured to utilize data obtain from the GNSS 20 to determine a geographical location of the vehicle 10.

As mentioned, the brake system 14 of the vehicle 10 is preferably an air-controlled brake system 14. Air-controlled brake systems 14, commonly known as air brake systems, are typically used in heavy-duty vehicles such as trucks, buses, and commercial vehicles. An exemplary air-controlled brake system 14 is shown in FIG. 2. The air-controlled brake system 14 of FIG. 2 operates using compressed air to control the application and release of brakes 14b of the vehicle 10. Air-controlled brake system 14 are commonly known and will not be excessively explained, but generally comprise, in addition to the brakes 14b (brake actuators comprising brake chambers, release mechanisms etc.) and controllers 14c (brake pedal etc.), an air compressor 14a and a reservoir tank 14r. The air compressor 14a is generally driven by the vehicle's propulsion source 12. The air compressor 14a pressurizes air from the atmosphere, generating compressed air that is stored in the reservoir tank 14r (also known as air tank). The reservoir tank 14r serves as a storage vessel for the compressed air and ensures a steady and reliable air supply to the brake system 14. Generally, air-controlled brake systems 14 comprise and emergency brake system (not shown in FIG. 2) as a safety feature. In the event of a loss of air pressure or other failure in the system, the emergency brake system is automatically activated to engage the brakes and bring the vehicle to a stop. An air-controller brake system 14 is generally configured such that the brakes 14a are activated upon release of air pressure, and de-activated by applying air pressure. As an effect, if the compressed air system fails, i.e. no compressed air available, release of the brakes will be prevented and propelling of the vehicle 10 prohibited.

The air-controlled brake system 14 is, in other words, a safety critical feature of vehicles and propulsion of the vehicle without compressed air will not be possible. Consequently, a system may safely rely on the presence of compressed air from the air-controlled brake system 14 during operation of the vehicle 10.

In order to extend a lifetime and ensure efficiency of the air compressor 14a, the air compressor 14a is generally provided with one or more air dryers 14d arranged to remove moisture and contaminants from the compressed air before it enters the brake system. Air dryers 14d are typically installed between the air compressor 14a and the air reservoir 14r. The air dryer 14d of the air-controlled brake system 14 may be of any suitable type. One common type of air dryer 14d uses desiccant materials such as silica gel or activated alumina to absorb moisture from the compressed air. Another type of air dryer 14d utilizes coalescing filters to remove water droplets and oil mist from the compressed air. These filters consist of fine fibers that capture and trap moisture and oil particles as the air passes through them. Some air dryers 14d employ heat exchangers to cool the compressed air, causing the moisture to condense and separate from the air stream. The condensed water is then drained out of the system, leaving behind dry, clean air. The air dryer 14d may very well be a combination of different types of air dryers 14d.

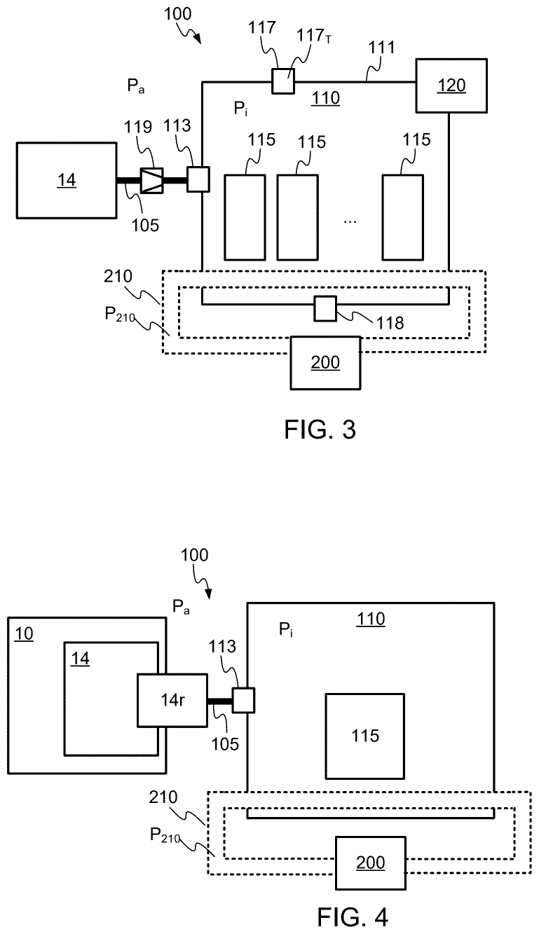

In FIG. 3, an exemplary schematic view of an energy source 100 in the form of a battery system 100 is shown. The battery system 100 comprises at least one battery pack 110 (only one shown in FIG. 3). The battery pack 110 may be any suitable battery pack 110 and may comprise one or more battery cells 115. In FIG. 3, the battery system 100 comprises three battery cells 115 but this is for illustrative purposes and the battery system 100 may comprise any number of battery cells 115. The battery pack 110 further comprises a housing 111 for sealing the battery pack 110. The housing 111 of the battery pack 110 may be any suitable housing and may be chosen depending on e.g. specific applications, requirements and/or an expected operational environment of the battery pack 110. In some examples, the housing 111 may be a metal casing, a plastic casing or casing comprised both of metal and plastic or other types of custom enclosures for the battery cells 115. In some examples, the battery cells 115 may be provide with cell casing (not shown) and such cell casing may correspond to the housing 111 but may be provided as soft or flexible pouches or casings. The teaching of the present disclosure may be applied also to suitable battery cell cases.

Some battery packs 110, specifically high-performance battery packs, such as those used in electric vehicles or grid-scale energy storage, often incorporate connections to a cooling systems 200 at their housing 111 to manage temperature and optimize performance and lifespan of the battery pack 110. The cooling system 200 may by an external cooling system 200 such as shown in FIG. 3, or integrated within the housing 111. The cooling system 200 of FIG. 3 is a liquid cooling system comprising coolant lines 210 connected to the battery pack 110. The coolant lines 210 function as conduits for coolant with which the battery pack 110 may exchange heat. Coolant lines 210 may extend through the housing 111 of the battery pack 110 and/or be connected/arranged in a vicinity of the battery pack 110. The coolant lines 210 may comprise, be formed as, and/or connected to heat exchangers (e.g. cooling plates) arranged to exchange heat with the battery pack 110. Additionally, or alternatively, coolant lines 210 and/or heat exchangers may be incorporated in the housing 111 of the battery pack 110. A battery pack 110 connected to, or comprising, liquid cooling system 200 is referred to as a liquid-cooled battery pack 110. A battery pack 110 connected to a cooling system 200 providing liquid-cooling may be referred to as a liquid-cooled battery pack 110.

The battery pack 110 further comprises a high pressure inlet valve 113. The high pressure inlet valve 113 may be arranged as a connection through the housing 111 of the battery pack 110. The high pressure inlet valve 113 is connected to a compressed air supply 105 provided to enable operative connection of the battery pack 110 to a supply of compressed air. In FIG. 3 the compressed air supply 105 is connected to an air-controlled brake system 14 such as the air-controlled brake system of FIG. 2. The compressed air supply 105 is preferably connected to an outlet of the reservoir tank 14r of the air-controlled brake system 14. It should be mentioned that, although named high pressure inlet valve 113, valve functionality is not required by the high pressure inlet valve 113, the high pressure inlet valve 113 may, in some examples, be a connector to enable connection of the battery pack 110 to the compressed air supply 105. In some examples, the high pressure inlet valve 113 is a pressure-controlling valve configured to control an internal pressure Pᵢ of the battery pack 110 to be greater than an ambient air pressure Pₐ of the battery pack 110.

Generally, a pressure of the compressed supply air is greater than a wanted internal pressure Pᵢ of the battery pack 110. To this end, the battery system 100 may comprise a pressure-reducing valve 119 arranged between the compressed supply and the housing 111. Alternatively, or additionally, the high pressure inlet valve 113 may comprise the pressure-reducing valve 119. The pressure reducing valve 119 may be configured to reduce a pressure provided via the compressed air supply 105, e.g. a pressure of the reservoir tank 14r of the air-controlled brake system 14, to a lower pressure manageable by housing 111 of the battery pack 110, but greater than the ambient pressure Pₐ of the battery pack 110. The pressure-reducing valve 119 may be any suitable pressure-reducing valve 119 such as, but not limited to direct-acting pressure reducing valves (comparably simple, reliable devices that operate based on the balance between the downstream pressure and a spring force), pilot-operated pressure reducing valves (valves using a pilot valve to control the main valve, providing greater accuracy and sensitivity to changes in pressure where the pilot valve senses the downstream pressure and modulates the main valve to maintain a desired pressure setpoint), diaphragm pressure reducing valves (valves using a flexible diaphragm to control the flow of air and maintain the desired pressure downstream) etc.

In some examples, the pressure-reducing valve 119 and/or the high pressure inlet valve 113 is a controllable valve; such that the control of the internal pressure Pᵢ of the battery pack 110 to be greater than an ambient air pressure Pₐ of the battery pack 110 may be selective. Additionally, or alternatively, the pressure-reducing valve 119 and/or the high pressure inlet valve 113 is a controllable valve such that the internal pressure Pᵢ of the battery pack 110 may be controlled to a configurable wanted internal pressure Pᵢ of the battery pack 110.

In some examples, the battery pack 110 further comprises a pressure relief valve 117. The pressure relief valve 117 is generally provided through the housing 111 of the battery pack 110. The pressure relief valve 117 may be configured to serve as a safety mechanism to protect the battery pack 110 and surrounding components from damage due to overpressure conditions. Generally, a primary purpose of a pressure relief valve in a battery pack 110 is to prevent the buildup of excessive internal pressure, which can occur during abusive conditions such as overcharging, external short circuits, or thermal runaway. The pressure relief valve 117 is configured to open and allow gases to pass from an inside of the housing 111 to an outside of the housing 111. The pressure relief valve is configured to open responsive to the internal pressure Pᵢ of the battery pack 110 exceeding a pressure relief threshold 117_{T} of the pressure relief valve 117. If the battery pack 110 is provided with a pressure relief valve 117, the pressure inlet valve 113 is preferably configure to provide the internal pressure Pᵢ of the battery pack 110 to be lower than the pressure relief threshold 117_{T} and above the ambient air pressure Pₐ of the battery pack 110.

It should be mentioned that the internal pressure Pᵢ of the battery pack 110 may very well be greater than the pressure relief threshold 117_{T}. This will cause air from the compressed air supply, e.g. the reservoir tank 14r of the air-controlled brake system 14, to enter the hosing 111 through the pressure inlet valve 113 and escape the housing 111 through the pressure relief valve 117. This allows exchange of air inside the battery pack 110 and evacuation of e.g. moisture, contaminants etc. from the battery pack 110. In some examples, the pressure-reducing valve 119 and/or the high pressure inlet valve 113 is a controllable valve as mentioned above; and the controllable pressure-reducing valve 119 and/or the controllable high pressure inlet valve 113 may be controlled to selectively provide the internal pressure Pᵢ of the battery pack 110 to be lower than the pressure relief threshold 117_{T} and above the ambient air pressure Pₐ of the battery pack 110, or above the pressure relief threshold 117_{T}. This provides selective evacuation of air from the battery pack 111.

Optionally, the battery pack 110 may be provided with an outlet valve 118. Preferably, the outlet valve 118 is a controllable outlet valve 118. The outlet valve 118 enables selective evacuation of air from the battery pack 111. In some examples, the outlet valve 118 is arranged at a vertically low, preferably at a vertically lowest, portion of the battery pack 110. Having the outlet valve 118 at a lower portion of the battery pack 110 (or the housing 111 of the battery pack 110), allows draining of liquid and moisture from battery pack 110, i.e. an interior of the housing 111.

Although the functionality of the battery system 120 outlined above may be provided wholly by hardware components such as valves etc., control of these valves may, as indicated above, in some examples be configurable. To this end, the battery system 100 may further comprise (or be operatively connected to) processing circuitry 120. The processing circuitry 120 may be any suitable processing circuitry configured to control the internal pressure Pᵢ of the battery pack 110. The processing circuitry 120 may be configured to control the internal pressure Pᵢ of the battery pack 110 by engaging the high pressure inlet valve 113, the pressure-reducing valve 119 and/or the outlet valve 118. In some examples, the processing circuitry 120 is operatively connected to the air-controlled brake system 14 and configured to control the air-controlled brake system 14 to provide the internal pressure Pᵢ of the battery pack 110.

It should be mentioned that the battery pack 110 may very well comprise further devices and/or features such as, but not limited to, one or more controllers, sensors, connectors, further safety features etc.

Providing an internal pressure Pᵢ of the battery pack 110 to be above an ambient air pressure Pₐ of the battery pack 110 will prevent contaminants, moisture etc. to leak into the battery pack 110 if the housing 111 is damaged. Further to this, in case of a liquid-cooled battery pack 110, if the coolant lines 210 of a liquid cooling system 200 are damaged, coolant will be prevented from leaking into the battery pack 110. If walls of the coolant lines 210 form walls of the housing 110, air may leak into the liquid cooling system 200 rather than coolant leaking into the battery pack 110. Air in the cooling system 200 is generally easier to detect and less hazardous than coolant inside the battery pack 110. It should be mentioned that, in cases where the walls of the coolant lines 210 form walls of the housing 110, the high pressure inlet valve 113 is preferably configured to provide the internal pressure Pᵢ of the battery pack above an internal pressure of the coolant lines P₂₁₀, specifically if the internal pressure of the coolant lines P₂₁₀ is greater than the ambient air pressure Pₐ of the battery pack 110 which is generally the case.

In FIG. 4, one preferred example of a battery system 100 is shown. The battery system 100 comprises a liquid-cooled battery pack 110 and a compressed air supply 105 connected to a high pressure inlet valve 113 of the battery pack 110 and connectable to an air-controlled brake system 14 of a vehicle 10. The battery system 100 is configured to control an internal pressure Pᵢ of the battery pack 110 to be greater than an ambient air pressure Pₐ.

The battery system 100 of FIG. 4 may be modified to comprise any of the features indicated, or reduced by removal of any of the features indicated as optional, in reference to FIG. 3. In some examples, the battery pack 110 is connected to the air-controlled brake system 14 of a vehicle 10. In some examples, the battery pack 110 comprises the air-controlled brake system 14 of a vehicle 10.

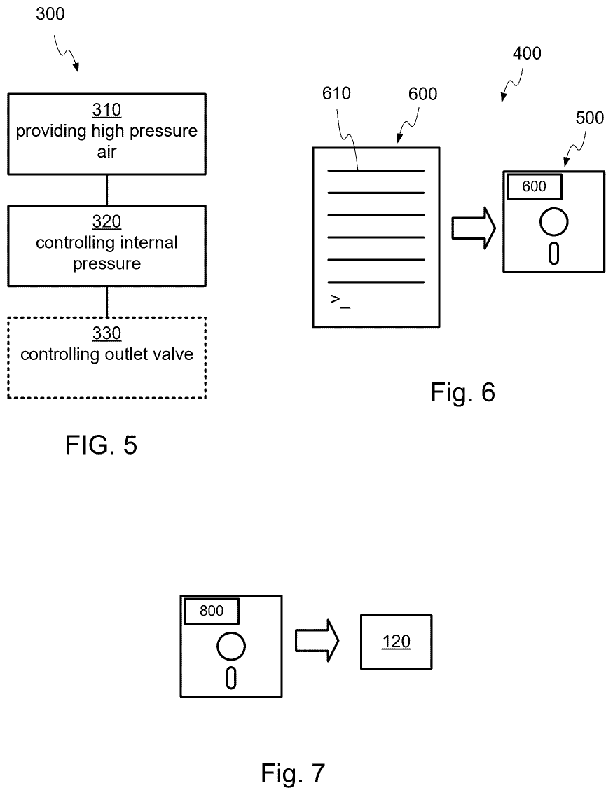

With reference to FIG. 5, a schematic view of a method 300 according to the present disclosure is shown. The method 300 may be a partly or wholly computer implemented method 300. The processing circuitry 120 of the battery system 100 or processing circuitry of the vehicle 10 operatively connected to the battery system 100 may be configured to perform and/or cause performance of some or all features of the method 300.

The method 300 may be described as a method 300 for controlling an internal pressure Pᵢ of a battery pack 110 to be greater than an ambient air pressure Pₐ of the battery pack 110. To this end, the method comprises providing 310 high pressure air from a compressed air tank 14r of an air-controlled brake system 14 of a vehicle 10 to a high pressure inlet valve 113 of the battery pack 110. Providing 310 the high pressure air may be accomplished according to any example, feature or function presented herein, e.g. with reference to FIG. 3.

The method 300 further comprises controlling 320 the internal pressure Pᵢ of the battery pack 110) to be greater than an ambient air pressure Pₐ. Controlling 320 the high pressure air may be accomplished according to any example, feature or function presented herein, e.g. with reference to FIG. 3. In some examples, specifically examples wherein the battery pack 110 comprises the preciously introduced pressure relief valve 117, controlling 320 the high pressure air may comprise controlling the internal pressure Pᵢ of the battery pack 110 to be below the pressure relief threshold 117r of the pressure relief valve 117, but above the ambient air pressure Pₐ. In some examples, specifically examples wherein the battery pack 110 is a liquid-cooled battery where there is a risk of ruptured or damaged coolant lines 210 leaking coolant directly into the housing 111 (an inner wall of the housing 111 is an outer wall of a coolant line 210), controlling 320 the high pressure air may comprise controlling the internal pressure Pᵢ of the battery pack 110 to be above a predetermined internal pressure P₂₁₀ of the coolant of the cooling system 200.

Optionally, in some examples, specifically examples wherein the battery pack 110 comprises the previously introduced controllable outlet valve 118, the method 300 may further comprise controlling 330 the controllable outlet valve 118 to controllably release air from the battery pack 110. Controlling 330 the controllable outlet valve 118 may be accomplished according to any example, feature or function presented herein, e.g. with reference to FIG. 3.

The method 300 introduced with reference to FIG. 5 may be modified to comprise any or all features, examples or functionality presented herein.

In FIG. 6 a computer program product 400 is shown. The computer program product 400 comprises a computer program 600 and a non-transitory computer readable medium 500. The computer program 600 may be stored on the computer readable medium 500. The computer readable medium 500 is, in FIG. 6, exemplified as a vintage 5,25″ floppy disc, but may be embodied as any suitable non-transitory computer readable medium such as, but not limited to, hard disk drives (HDDs), solid-state drives (SSDs), optical discs (e.g., CD-ROM, DVD-ROM, CD-RW, DVD-RW), USB flash drives, magnetic tapes, memory cards, Read-Only Memories (ROM), network-attached storage (NAS), cloud storage etc.

The computer program 600 comprises instruction 610 e.g. program instruction, software code, that, when executed by processing circuitry cause the processing circuitry to perform the method 300 introduced with reference to FIG. 5.

As illustrated in FIG. 7, the computer program 600 may be loaded onto the processing circuitry 120 of the battery system 100.

In the following, a list of specific examples of embodiments of the present invention are presented. However, the scope of protection is defined in the appended independent claims with preferred embodiments defined in the dependent claims related thereto.

Example 1. A battery system 100 comprising a liquid-cooled battery pack 110 and a compressed air supply 105 connected to a high pressure inlet valve 113 of the battery pack 110 and connectable to an air-controlled brake system 14 of a vehicle 10, wherein the battery system 100 is configured to control an internal pressure Pᵢ of the battery pack 110 to be greater than an ambient air pressure Pₐ.

Example 2. The battery system 100 of example 1, wherein the battery pack 110 comprises a pressure relief valve 117 configured to open responsive to the internal pressure Pᵢ of the battery pack 110 being above a pressure relief threshold 117_{T}, and the battery system 100 is further configured to control the internal pressure Pᵢ of the battery pack 110 to be below the pressure relief threshold 117_{T}.

Example 3. The battery system 100 of example 1 or 2, wherein the internal pressure Pᵢ of the battery pack 110 is controlled by a pressure reducing valve 119 arranged between and in fluid connection with the compressed air supply 105 and the high pressure inlet valve 113.

Example 4. The battery system 100 of any one of examples 1 to 3, wherein the high pressure air supply 105 comprises an air dryer 14d.

Example 5. The battery system 100 of any one of examples 1 to 4, further configured to control the internal pressure Pᵢ of the battery pack 110 to be greater than a predetermined internal pressure P₂₁₀ of a cooling liquid of a cooling system 200 configured to cool the battery pack 110.

Example 6. The battery system 100 of any one of examples 1 to 5, wherein the battery pack 110 further comprises a controllable outlet valve 118 and the battery system 100 is further configured to control the controllable outlet valve 118 to controllably release air from the battery pack 110.

Example 7. The battery system 100 of example 6, wherein the controllable outlet valve 118 is arranged at an, during use, vertically lower portion of the battery pack 110 to allow draining of moisture from the battery pack 110.

Example 8. The battery system 100 of any one of examples 1 to 7, further comprising processing circuitry 120 configured to control the internal pressure Pᵢ of the battery pack 110.

Example 9. The battery system 100 of examples 1, further comprising a pressure relief valve 117 configured to open responsive to the internal pressure Pᵢ of the battery pack 110 being above a pressure relief threshold 117_{T}, and the battery system 100 is further configured to control the internal pressure Pᵢ of the battery pack 110 to be below the pressure relief threshold 117_{T}; the internal pressure Pᵢ of the battery pack 110 is controlled by a pressure reducing valve 119 arranged between and in fluid connection with the compressed air supply 105 and the high pressure inlet valve 113; the high pressure air supply 105 comprises an air dryer 14d; the battery system 100 is configured to control the internal pressure Pᵢ of the battery pack 110 to be greater than a predetermined internal pressure P₂₁₀ of a cooling liquid of a cooling system 200 configured to cool the battery pack 110; the battery pack 110 further comprises a controllable outlet valve 118 and the battery system 100 is further configured to control the controllable outlet valve 118 to controllably release air from the battery pack 110; the controllable outlet valve 118 is arranged at an, during use, vertically lower portion of the battery pack 110 to allow draining of moisture from the battery pack 110; the battery system further comprising processing circuitry 120 configured to control the internal pressure Pᵢ of the battery pack 110.

Example 10. A vehicle 10, comprising a battery system 100 of any one of examples 1 to 9 and an air-controlled brake system 14 wherein a reservoir tank 14r of the air-controlled brake system 14 is operatively connected to the compressed air supply 105 of the battery system 100.

Example 11. The vehicle 10 of example 10, wherein the vehicle is a heavy-duty vehicle.

Example 12. A method 300 for controlling an internal pressure Pᵢ of a liquid-cooled battery pack 110, the method 300 comprising: providing 310 high pressure air from a compressed air tank 14r of an air-controlled brake system 14 of a vehicle 10 to a high pressure inlet valve 113 of the battery pack 110, and controlling 320 the internal pressure Pᵢ of the battery pack 110 to be greater than an ambient air pressure Pₐ.

Example 13. The method 300 of example 12, wherein the battery pack 110 comprises a pressure relief valve 117 configured to open responsive to the internal pressure Pᵢ of the battery pack 110 being above a pressure relief threshold 117_{T}, and the method 300 further comprises: controlling 320 the internal pressure Pᵢ of the battery pack 110 to be below the pressure relief threshold 117_{T}.

Example 14. The method 300 of example 12 or 13, wherein the battery pack 110 further comprises a controllable outlet valve 118, and the method 300 further comprising: controlling 330 the controllable outlet valve 118 to controllably release air from the battery pack 110.

Example 15. The method 300 of any one of examples 12 to 14, further comprising: controlling 320 the internal pressure Pᵢ of the battery pack 110 to be greater than a predetermined internal pressure P₂₁₀ of a cooling liquid of a cooling system 200 configured to cool the battery pack 110.

Example 16. Processing circuitry 120 configured to cause performance of the method 300 of any one of examples 12 to 15.

Example 17. A battery system 100 comprising a liquid-cooled battery pack 110, a compressed air supply 105 connected to a compressed air supply of an air-controlled brake system 14 of a vehicle 10, and the processing circuitry 120 of example 16.

Example 18. A computer program product 400 comprising program code 610 for performing, when executed by processing circuitry 120, the method 300 of any of examples 12 to 15.

Example 19. A non-transitory computer-readable storage medium 500 comprising instructions 610, which when executed by processing circuitry 120, cause the processing circuitry 120 to perform the method 300 of any of examples 12 to 15.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

What is claimed is:

1. A battery system comprising a liquid-cooled battery pack and a compressed air supply connected to a high pressure inlet valve of the battery pack and connectable to an air-controlled brake system of a vehicle, wherein the battery system is configured to control an internal pressure of the battery pack to be greater than an ambient air pressure.

2. The battery system of claim 1, wherein the battery pack comprises a pressure relief valve configured to open responsive to the internal pressure of the battery pack being above a pressure relief threshold, and the battery system is further configured to control the internal pressure of the battery pack to be below the pressure relief threshold.

3. The battery system of claim 1, wherein the internal pressure of the battery pack is controlled by a pressure reducing valve arranged between and in fluid connection with the compressed air supply and the high pressure inlet valve.

4. The battery system of claim 1, wherein the high pressure air supply comprises an air dryer.

5. The battery system of claim 1, further configured to control the internal pressure of the battery pack to be greater than a predetermined internal pressure of a cooling liquid of a cooling system configured to cool the battery pack.

6. The battery system of claim 1, wherein the battery pack further comprises a controllable outlet valve and the battery system is further configured to control the controllable outlet valve to controllably release air from the battery pack.

7. The battery system of claim 6, wherein the controllable outlet valve is arranged at an, during use, vertically lower portion of the battery pack to allow draining of moisture from the battery pack.

8. The battery system of claim 1, further comprising processing circuitry configured to control the internal pressure of the battery pack.

9. The battery system of claim 1, further comprising a pressure relief valve configured to open responsive to the internal pressure of the battery pack being above a pressure relief threshold, and the battery system is further configured to control the internal pressure of the battery pack to be below the pressure relief threshold; the internal pressure of the battery pack is controlled by a pressure reducing valve arranged between and in fluid connection with the compressed air supply and the high pressure inlet valve; the high pressure air supply comprises an air dryer; the battery system is configured to control the internal pressure of the battery pack to be greater than a predetermined internal pressure of a cooling liquid of a cooling system configured to cool the battery pack; the battery pack further comprises a controllable outlet valve and the battery system is further configured to control the controllable outlet valve to controllably release air from the battery pack; the controllable outlet valve is arranged at an, during use, vertically lower portion of the battery pack to allow draining of moisture from the battery pack; the battery system further comprising processing circuitry configured to control the internal pressure of the battery pack.

10. A vehicle, comprising a battery system of claim 1 and an air-controlled brake system wherein a reservoir tank of the air-controlled brake system is operatively connected to the compressed air supply of the battery system.

11. The vehicle of claim 10, wherein the vehicle is a heavy-duty vehicle.

12. A method for controlling an internal pressure of a liquid-cooled battery pack, the method comprising:
providing high pressure air from a compressed air tank of an air-controlled brake system of a vehicle to a high pressure inlet valve of the battery pack, and
controlling the internal pressure of the battery pack to be greater than an ambient air pressure.

13. The method of claim 12, wherein the battery pack comprises a pressure relief valve configured to open responsive to the internal pressure of the battery pack being above a pressure relief threshold, and the method further comprises:
controlling the internal pressure of the battery pack to be below the pressure relief threshold.

14. The method of claim 12, wherein the battery pack further comprises a controllable outlet valve, and the method further comprising:
controlling the controllable outlet valve to controllably release air from the battery pack.

15. The method of claim 12, further comprising:
controlling the internal pressure of the battery pack to be greater than a predetermined internal pressure of a cooling liquid of a cooling system configured to cool the battery pack.

16. Processing circuitry configured to cause performance of the method of claim 12.

17. A battery system comprising a liquid-cooled battery pack, a compressed air supply connected to a compressed air supply of an air-controlled brake system of a vehicle, and the processing circuitry of claim 16.

18. A computer program product comprising program code for performing, when executed by processing circuitry, the method of claim 12.

19. A non-transitory computer-readable storage medium comprising instructions, which when executed by processing circuitry, cause the processing circuitry to perform the method of claim 12.
